(19) United States
(12) Patent Application Publication
(10) Pub. No.: US 2009/0142663 A1
(43) Pub. Date: Jun. 4, 2009

(54) NONAQUEOUS ELECTROLYTE SECONDARY BATTERY AND METHOD OF PRODUCING THE SAME

(76) Inventors: Takashi Takeuchi, Osaka (JP); Takaya Saito, Tochigi (JP); Takayuki Shirane, Osaka (JP); Atsushi Ueda, Osaka (JP)

Correspondence Address: MCDERMOTT WILL & EMERY LLP, 600 13TH STREET, NW, WASHINGTON, DC, 20005-3096, US

(21) Appl. No.: 11/885,456

(22) PCT Filed: Jul. 19, 2006
(86) PCT No.: PCT/JP2006/314224

§ 371 Date: Aug. 31, 2007

(30) Foreign Application Priority Data
Jul. 21, 2005 (JP) 2005-210929

(51) Int. Cl. H01M 10/40

(52) U.S. Cl. 429/188; 29/623.1

(57) ABSTRACT

A nonaqueous electrolyte secondary battery, comprising a positive electrode containing a transition metal-containing composite oxide as a positive electrode active material, a negative electrode containing a negative electrode active material allowing reversible insertion and extraction of lithium, a separator, and a nonaqueous electrolyte solution, wherein the nonaqueous electrolyte solution contains at least one additive (A) selected from the group consisting of ethylene sulfite, propylene sulfite, and propane sultone and at least one additive (B) selected from the group consisting of maleic anhydride, vinylene carbonate, vinylethylene carbonate, and LiBF₄; and an end voltage of charge is 4.3 to 4.5 V.

### FIELD OF THE INVENTION

The present invention relates to a nonaqueous electrolyte secondary battery and a method of producing the same, and more specifically, to improvement of discharge rate characteristics and high-temperature storage characteristics of a nonaqueous electrolyte secondary battery by using a high end voltage of charge.

### BACKGROUND OF THE INVENTION

Nonaqueous electrolyte secondary batteries represented by lithium-ion secondary batteries have high operational voltage and high energy density. For that reason, lithium-ion secondary batteries are commercialized as an operational power source for portable electronic devices such as cellphone, laptop computer and video camcorder, and are gaining an increasing demand rapidly. A typical lithium-ion secondary battery has as its main components a positive electrode containing lithium cobaltate, a transition metal-containing composite oxide, as a positive electrode active material, a negative electrode containing a carbon material as a negative electrode active material, a separator of a microporous film, and a nonaqueous electrolyte solution containing a solute such as lithium hexafluorophosphate (LiPF₆) dissolved in a nonaqueous solvent such as a cyclic or linear carbonate ester or a cyclic carboxylate ester.

Along with recent increase in the performance of cellphone, for example, there is a demand for a high-capacity lithium-ion secondary battery superior in discharge rate characteristics at large current. Such a lithium-ion secondary battery having these properties is prepared by a method, for example, of increasing the capacity of the active material itself on the positive and negative electrodes, or alternatively, raising the end voltage of charge of the battery to obtain larger capacity from an active material. Generally, the end voltage of charge of a lithium-ion secondary battery is set to about 4.1 to 4.2 V, taking into consideration the charge/discharge characteristics of the commonly-used positive electrode active material lithium cobaltate. For that reason, for example, a means of raising the depth of charge and the capacity of a positive electrode active material by using a transition metal-containing composite oxide (LiNi_{1-q-r}Mn_{q}CoᵣO₂) containing Co, part of which is replaced with Ni and Mn, as the positive electrode active material and setting the end voltage of charge to a high voltage of 4.25 to 4.7 V was proposed earlier by the applicant (Patent Document 1). On the other hand, improvement of the nonaqueous electrolyte solution for stabilization of the battery performance of lithium-ion secondary batteries was also carried out intensively. For example, proposed was a method of adding propane sultone or 1,4-butane sultone to a nonaqueous electrolyte solution (Patent Document 2). According to Patent Document 2, presence of the sultone, which forms a protective film on the surface of the negative electrode active material carbon material, is effective in suppressing decomposition of the electrolyte solution and thus, improving the durability of the battery (cycle characteristic). Accordingly, use of the method of Patent Document 2 in combination would be effective, because decomposition reactions of various battery materials are activated through the active material surface on the positive and negative electrodes, when a high end voltage of charge is used in a battery using a transition metal-containing composite oxide containing Co, part of which is replaced with other elements, as a positive electrode active material, as described in Patent Document 1.

However, it was difficult to obtain a lithium-ion secondary battery superior in the battery characteristics as desired only by using the methods above in combination. Specifically, studies in the present invention revealed that, in a lithium-ion secondary battery using a transition metal-containing composite oxide containing Co, part of which is replaced with other elements, as the positive electrode active material to set a high end voltage of charge and employing a nonaqueous electrolyte solution containing a sultone-based additive added in a great amount for preventing decomposition of the electrolyte solution on the negative electrode surface, discharge rate characteristics often declined by the great amount of the additive contained in the nonaqueous electrolyte solution. In addition, storage of the battery at high temperature in the high-voltage charged state raised a problem that discharge capacity declined significantly after the storage. In a trend toward expansion of the use of lithium-ion secondary batteries, the discharge characteristics and the high-temperature storage characteristics are both particularly of importance.

### Patent Document 1: Japanese Unexamined Patent Publication No. 2004-05539

### Patent Document 2: Japanese Unexamined Patent Publication No. 2000-003724

### DISCLOSURE OF THE INVENTION

An object of the present invention, which was made to solve the problems above, is to provide a nonaqueous electrolyte secondary battery superior in discharge rate characteristics even when high end voltage of charge is used for increase in capacity, and superior in high-temperature storage characteristics to be lower in deterioration of capacity when a charged-state battery is stored at high temperature.

As an aspect of the present invention, there is provided a nonaqueous electrolyte secondary battery, comprising a positive electrode containing a transition metal-containing composite oxide as a positive electrode active material, a negative electrode containing a negative electrode active material allowing reversible insertion and extraction of lithium, a separator, and a nonaqueous electrolyte solution, wherein the nonaqueous electrolyte solution contains at least one additive (A) selected from the group consisting of ethylene sulfite, propylene sulfite, and propane sultone and at least one additive (B) selected from the group consisting of maleic anhydride, vinylene carbonate, vinylethylene carbonate, and LiBF₄, and an end voltage of charge is 4.3 to 4.5 V.

The objects, features, aspects, and advantages of the present invention will become more evident in the following detailed description and the drawings attached.

### BRIEF DESCRIPTION OF THE DRAWINGS

FIG. 1 is a schematic sectional view illustrating an example of the nonaqueous electrolyte secondary battery according to the present invention.

### DESCRIPTION OF THE PREFERRED EMBODIMENTS

As described above, an aspect of the present invention is a nonaqueous electrolyte secondary battery comprising a positive electrode containing a transition metal-containing composite oxide as a positive electrode active material, a negative electrode containing a negative electrode active material allowing reversible insertion and extraction of lithium, a separator, and a nonaqueous electrolyte solution, wherein the nonaqueous electrolyte solution contains at least one additive (A) selected from the group consisting of ethylene sulfite (hereinafter, referred to as ES), propylene sulfite (hereinafter, referred to as PRS), and propane sultone (hereinafter, referred to as PS) and at least one additive (B) selected from the group consisting of maleic anhydride (hereinafter, referred to as MA), vinylene carbonate (hereinafter, referred to as VC), and vinylethylene carbonate (hereinafter, referred to as VEC), and LiBF₄, and an end voltage of charge is 4.3 to 4.5 V.

The inventors have found after studies that, in a nonaqueous electrolyte secondary battery having a higher end voltage of charge by using a transition metal-containing composite oxide containing Co, part of which is replaced with other elements, as a positive electrode active material for increase in capacity, the distinctive decrease in discharge capacity of a battery stored in the high-voltage charged state at high temperature is caused by increase in battery impedance due to elution of metal ions from the positive electrode active material into the nonaqueous electrolyte solution and deposition thereof on the negative electrode during storage. In particular, the transition metal-containing composite oxide containing Co, part of which is replaced with other elements, allows use of high charge voltage, but is considered to liberate metal ions in an amount greater than that of conventional positive electrode active materials. Accordingly when such a positive electrode active material is used, it was necessary to form a film on the negative electrode surface with an additive and also to restrict elution of the metal ions from the positive electrode surface.

Based on the findings above, investigated was a method of restricting elution of metal ions from the positive electrode surface even when a positive electrode containing a transition metal-containing composite oxide compatible with high voltage as a positive electrode active material is used. As a result of the investigation, it was found that a nonaqueous electrolyte secondary battery superior in discharge rate characteristics and high-temperature storage characteristics is obtained by using a nonaqueous electrolyte solution containing both at least one additive (A) selected from the group consisting of ES, PRS and PS and at least one additive (B) selected from the group consisting of MA, VC, VEC and LiBF₄.

The reasons for it are still yet to be understood. However, electron probe X-ray microanalysis (EPMA) of a battery using a nonaqueous electrolyte solution containing PS as additive (A) and LiBF₄ as additive (B) showed presence of components seemingly derived from the respective additives on the surface of positive and negative electrodes (a sulfur-containing component on the positive electrode and a boron-containing component on the negative electrode), indicating that film formation by the additives proceeds competitively on the electrode surface when both additives are copresent in the nonaqueous electrolyte solution. Thus, at low voltage, when the additive (A) is present alone in the nonaqueous electrolyte solution, it naturally decomposes on the negative electrode surface to form a film. However, when the both additives are copresent in the nonaqueous electrolyte solution, the additive (B) decomposes more preferentially than the additive (A) on the negative electrode surface to form a film, thus reducing the negative electrode surface region that can interact with the additive (A). The additive (A), which is considered to form the film on the negative electrode surface, interacts with the transition metal-containing composite oxide in a high-voltage charged state, and become adsorbed or decomposed to form a film mainly on the positive electrode surface. The film formed by the interaction between the transition metal-containing composite oxide and the additive (A) in the high-voltage state seemingly reduces elution of metal ions from the positive electrode active material drastically when the battery in the charged state is stored at high temperature and thus, improves the high-temperature storage characteristics. In a nonaqueous electrolyte solution containing only an additive (A), the additive (A) also forms the film preferentially more on the negative electrode than on the positive electrode, and thus, if added in a great amount, it does not improve the high-temperature storage characteristics and also leads to increase in impedance of the nonaqueous electrolyte solution by the increased amount of the additive and deterioration in discharge rate characteristics at large current. In contrast, in the nonaqueous electrolyte solution containing both additives (A) and (B), the additive (B) forms the film preferentially on the negative electrode surface, keeping the total amounts of the both additives small, and the films formed by the both additives on respective electrode surfaces reduce increase of the impedance of the nonaqueous electrolyte solution, consequently improving the high-temperature storage characteristics without deterioration in the discharge rate characteristics.

In the description above, the every additive (A) has common features that it is a five-membered ring compound having a SO bond in the molecule, and interacts with the surface of the positive electrode containing a transition metal-containing composite oxide at a high voltage of 4.3 V or more to form a film. In addition, the every additive (B) has a common feature that it forms a film on the negative electrode surface at a voltage vs. Li potential higher than the potential at which ethylene carbonate, a generally used nonaqueous solvent for nonaqueous electrolyte solution, forms a film. Accordingly, the additive (B) forms a film during charge preferentially more than the nonaqueous solvent or the additive (A).

The amount of the additive (A) added to the nonaqueous electrolyte solution is preferably 0.03 to 5 mass %, more preferably 0.05 to 4 mass %. The amount of the additive (A) of 0.03 to 5 mass % allows favorable film formation on the positive electrode surface and prevents increase of the impedance of the nonaqueous electrolyte solution. Alternatively, the amount of the additive (B) added to the nonaqueous electrolyte solution is preferably 0.03 to 5 mass %, more preferably 0.05 to 4 mass %. The amount of the additive (B) of 0.03 to 5 mass % allows favorable film formation on the negative electrode surface and prevents increase of the impedance of the nonaqueous electrolyte solution. The mixing rate of the additive (A) to the additive (B) in the nonaqueous electrolyte solution is not particularly limited, but the rate of additive (A)/additive (B) by mass is preferably 1/3 to 3/1, more preferably 1/2 to 2/1, and most preferably almost 1/1, for sufficiently forming the films of the additives (A) and (B) respectively on the surfaces of the positive and negative electrodes.

The total amount of the additives (A) and (B) added is preferably 0.1 to 10 mass %, more preferably 0.1 to 8 mass %, and most preferably 0.1 to 4 mass %. It is possible to reduce the total amount of the additives added to the nonaqueous electrolyte solution, because the additive (B) forms a film preferentially on the negative electrode and the additive (A) forms a film on the positive electrode in the high-voltage charged state, as described above. Accordingly, even when the additives are added in the reduced amounts, it is possible to improve the high-temperature storage characteristics, thus prevent deterioration in discharge rate characteristics, enabling to keep the high-temperature storage characteristics and the discharge rate characteristics both at high levels.

The nonaqueous electrolyte solution contains a nonaqueous solvent and a lithium salt soluble in the nonaqueous solvent, in addition to the additives above. Examples of the nonaqueous solvents include aprotic organic solvents including cyclic carbonates such as ethylene carbonate (EC), propylene carbonate (PC), and butylene carbonate (BC); noncyclic carbonates such as dimethyl carbonate (DMC), diethyl carbonate (DEC), ethyl methyl carbonate (EMC), and dipropyl carbonate (DPC); and the like. These nonaqueous solvents may be used alone or in combination of two or more. Among them, a nonaqueous solvent containing a cyclic carbonate and a noncyclic carbonate as principal components is preferable.

Examples of the lithium salts soluble in the solvent include LiClO₄, LiPF₆, LiAlCl₄, LiSbF₆, LiSCN, LiCl, LiCF₃SO₃, LiCF₃Co₂, Li(CF₃SO₂)₂, LiAsF₆, LiN(CF₃SO₂)₂, and the like, and among them, LiPF₆ is more preferable. These lithium salts may be used alone or in combination of two or more. The amount of the lithium salt dissolved is not particularly limited, but preferably 0.2 to 2 mol/L, more preferably 0.5 to 1.5 mol/L. LiBF₄ may be used as the lithium salt, but preferably used together with another lithium salt, because it decomposes on the negative electrode surface to form a film.

The combination of the nonaqueous solvent and the lithium salt is not particularly limited, but a nonaqueous electrolyte solution containing at least EC and EMC as the nonaqueous solvents and at least LiPF₆ as the lithium salts is preferable.

The positive electrode contains a transition metal-containing composite oxide such as LiCoO₂ or LiNiO₂ used in a nonaqueous electrolyte secondary battery as a positive electrode active material. Among these transition metal-containing composite oxides, preferable are transition metal-containing composite oxides, part of the Co of which is substituted with another element, that allow use at high end voltage of charge and formation of a high-quality film by adsorption or decomposition of the additive (A) on the surface in the high-voltage state. Typical examples of the transition metal-containing composite oxides include transition metal-containing composite oxides represented by General Formula LiₓNi_{1-(y+z)}Co_{y}M_{z}O₂ (wherein, 0.95≦x≦1.12; 0.01≦y≦0.35; 0.01≦z≦0.50; and M represents at least one element selected from the group consisting of Al, Mn, Ti, Mg, Mo, Y, Zr, and Ca). In particular, a transition metal-containing composite oxide containing Mn and at least one element selected from the group consisting of Al, Ti, Mg, Mo, Y, Zr, and Ca as M in the General Formula gives a nonaqueous electrolyte secondary battery higher in levels of both discharge rate characteristics and high-temperature storage characteristics and also superior in initial capacity characteristics and thermal stability. A transition metal-containing composite oxide above wherein x is less than 0.95 may give a battery smaller in battery capacity, while that wherein x is more than 1.12 leads to easier deposition of a lithium compound such as lithium carbonate on the active material surface and generation of gas during storage at high temperature. Alternatively, a composite oxide wherein y is less than 0.01 leads to deterioration of the crystal stability and the lifetime characteristics of the active material, while that wherein y is more than 0.35, to increased use in the amount of Co, a rare metal and thus in the cost of the active material itself. Further, a composite oxide wherein z is less than 0.01 may lead to deterioration in thermal stability, and that wherein z is more than 0.50, to deterioration in capacity. The specific surface area of the transition metal-containing composite oxide containing Co, part of which is replaced with other elements, is preferably 0.15 to 1.50 m²/g, more preferably 0.15 to 0.50 m²/g, and most preferably 0.15 to 0.30 m²/g. A specific surface area of less than 0.15 m²/g may lead to increase of the charge transfer resistance at the positive electrode active material surface and deterioration in discharge rate characteristics, while a specific surface area of more than 1.5 m²/g to increase of the elution of metal ions in the charged state during storage at high temperature. The specific surface area above is a value determined by a multi-point method of measuring the specific surface area at five different pressures according to the BET method by using nitrogen gas as the adsorption gas and by using a transition metal-containing composite oxide previously dried under vacuum at 110° C. for 3 hours as the sample. An example of the instrument for determining the specific surface area is ASAP2010 manufactured by Shimadzu Corp.

The transition metal-containing composite oxide can be prepared by a known method of mixing raw compounds in a ratio suitable for the composition of the final metal elements and sintering the mixture. Examples of the raw compounds for use include the oxides, hydroxides, oxyhydroxides, carbonate salts, nitrate salts, sulfate salts, organic complex salts, and others of the metal element forming the positive electrode active material. These compounds may be used alone or as a mixture of two or more.

In preparing the transition metal-containing composite oxide, it is preferable to prepare hydroxides of Co, Ni and other metal elements by using the raw compounds above, for example, by sedimentation method and to prepare a solid solution of the oxides by primarily sintering the hydroxides obtained. The primary sintering reduces the specific surface area of the oxide obtained. The primary sintering is preferably carried out, for example, at a temperature of 300 to 700° C. for 5 to 15 hours, although the condition may vary according to the kinds of the metal elements. It is possible to prepare the transition metal-containing composite oxide of the solid solution of respective metal elements, by secondarily sintering the mixture of the oxide obtained and a lithium compound such as lithium hydroxide.

A mixture of two or more transition metal-containing composite oxides may be used as the positive electrode active material. For example, a positive electrode active material of a mixture of LiCoO₂ and the transition metal-containing composite oxide containing Co, part of which is replaced with other elements, may be used. The amount of LiCoO₂ in the mixture is preferably 30 to 90 mass % with respect to the entire positive electrode active material. In addition, a transition metal-containing composite oxide in which part of the Co of LiCoO₂ different from the transition metal-containing composite oxide represented by the General Formula above is substituted with other elements may be used as a positive electrode active material. Examples of the replacing elements include Mg, Al, Zr, and Mo. By substituting Co with one or more elements selected from the group consisting of the replacing elements above, it is possible to improve heat resistance when the element is Mg or Al, and to improve the discharge polarization characteristics when the element is Zr or Mo. The total addition amount of the replacing elements, which are not involved in oxidation-reduction reaction, is preferably 10 mol % or less with respect to Co. An addition amount of 10 mol % or less is effective in reducing deterioration in the capacity of the positive electrode active material.

The positive electrode is prepared by applying a positive electrode mixture obtained by mixing the positive electrode active material and as needed a binder, a conductive substance and others on a current collector such as of aluminum. One or more electronically conductive materials that do not cause chemical change in the battery may be used as the conductive substance. Examples of the electronically conductive materials include graphites such as natural graphites (such as scaly graphite, etc.) and synthetic graphites; carbon blacks such as acetylene black (AB), Ketjen black, channel black, furnace black, lamp black, and thermal black; conductive fibers such as carbon fiber and metal fiber; conductive powders such as of carbon fluoride, copper, nickel, aluminum, and silver; conductive whiskers such as of zinc oxide and potassium titanate; conductive metal oxides such as titanium oxide; organic conductive materials such as polyphenylene derivatives; and the like. These materials may be used alone or in combination of two or more. Among these conductive substances, synthetic graphites, acetylene black, and nickel powder are particularly preferable. A polymer having a decomposition temperature of 300° C. or higher is preferable as the binder. Examples of the binders include polyethylene (PE), polypropylene (PP), polytetrafluoroethylene (PTFE), polyvinylidene fluoride (PVDF), tetrafluoroethylene-hexafluoroethylene copolymers, tetrafluoroethylene-hexafluoropropylene copolymers (FEP), tetrafluoroethylene-perfluoroalkyl vinylether copolymers (PFA), vinylidene fluoride-hexafluoropropylene copolymers, vinylidene fluoride-chlorotrifluoroethylene copolymers, ethylene-tetrafluoroethylene copolymers (ETFE resins), polychloro-trifluoroethylene (PCTFE), vinylidene fluoride-pentafluoropropylene copolymers, propylene-tetrafluoroethylene copolymers, ethylene-chlorotrifluoroethylene copolymers (ECTFE), vinylidene fluoride-hexafluoropropylene-tetrafluoroethylene copolymers, vinylidene fluoride-perfluoromethylvinylether-tetrafluoroethylene copolymers, carboxymethylcellulose (CMC) and the like. These resins may be used alone or in combination of two or more. Among them, PVDF and PTFE are particularly preferable.

As the negative electrode active materials, materials capable of reversively inserting and extracting lithium such as carbon materials, lithium-containing composite oxides, and materials forming an alloy with lithium can be used. Examples of the carbon materials include coke, pyrocarbons, natural graphite, synthetic graphite, mesocarbon microbeads, graphitized mesophase spheres, gas-phase-growth carbon, glassy carbons, carbon fiber (based on polyacrylonitrile, pitch cellulosic, or gas-phase-growth carbon), amorphous carbon, sintered organic carbon materials, and the like. These materials may be used alone or in combination of two or more. Among them, graphite materials such as mesophase spheres, graphitized carbon materials, natural graphites, and synthetic graphites are preferable. Examples of the materials that form an alloy with lithium include pure Si, compounds of Si and O (SiOₓ) and the like. These materials may be used alone or in combination of two or more. Use of the negative electrode active material of such a silicon-based compound leads to production of a nonaqueous electrolyte secondary battery with higher capacity.

The negative electrode is prepared by coating a negative electrode mixture obtained by mixing the negative electrode active material above and as needed a binder, a conductive substance, and others on a current collector such as of copper foil. When the carbon material is used as the negative electrode active material, the load capacity (X/Y) represented by the ratio of theoretical battery capacity (X) to the mass of the carbon material (Y) is preferably set in the range of 250 to 360 mAh/g. A load capacity in the range above allows smooth insertion and extraction of lithium and prevention of deterioration in polarization characteristics, and thus, allows production of a nonaqueous electrolyte secondary battery superior not only in high-temperature storage characteristics but also in discharge rate characteristics. The theoretical battery capacity above means a usable battery capacity calculated by subtracting the irreversible capacity of positive and negative electrodes occurring when charging and discharging is performed at the normal end voltage of the device in which the battery is used, from the positive electrode capacity determined by the theoretical capacity per unit mass of the positive electrode active material and the content of the positive electrode active material in positive electrode.

An electronically conductive material similar to that for the positive-electrode conductive substance may be used as the negative-electrode conductive substance. The binder may be a thermoplastic or thermosetting resin. Among them, a polymer having a decomposition temperature of 300° C. or higher is preferable. Examples of the binders include PE, PP, PTFE, PVDF, styrene butadiene rubbers (SBR), FEP, PFA, vinylidene fluoride-hexafluoropropylene copolymers, vinylidene fluoride-chlorotrifluoroethylene copolymers, ETFE resins, PCTFE, vinylidene fluoride-pentafluoropropylene copolymers, propylene-tetrafluoroethylene copolymers, ECTFE, vinylidene fluoride-hexafluoropropylene-tetrafluoroethylene copolymers, vinylidene fluoride-perfluoromethylvinylether-tetrafluoroethylene copolymers, CMC, and the like. These binders may be used alone or in combination of two or more. Among them, SBR and PVDF are preferable, and SBR is most preferable.

An insulative microporous thin film having large ion-permeability and a particular mechanical strength is used as the separator. A separator having a function to close its pore and raise its resistance at a particular temperature, for example at 120° C. or higher, is preferable. Examples of the separators include sheets, nonwoven fabrics and woven fabrics of an olefinic polymer of PP, PE, or both of them that has organic-solvent resistance and hydrophobicity, glass fiber, and the like.

The nonaqueous electrolyte secondary battery is assembled by placing an electrode assembly formed by winding or laminating the positive electrode and the negative electrode separated by the separator in a battery case, injecting the nonaqueous electrolyte solution therein, and sealing the battery case.

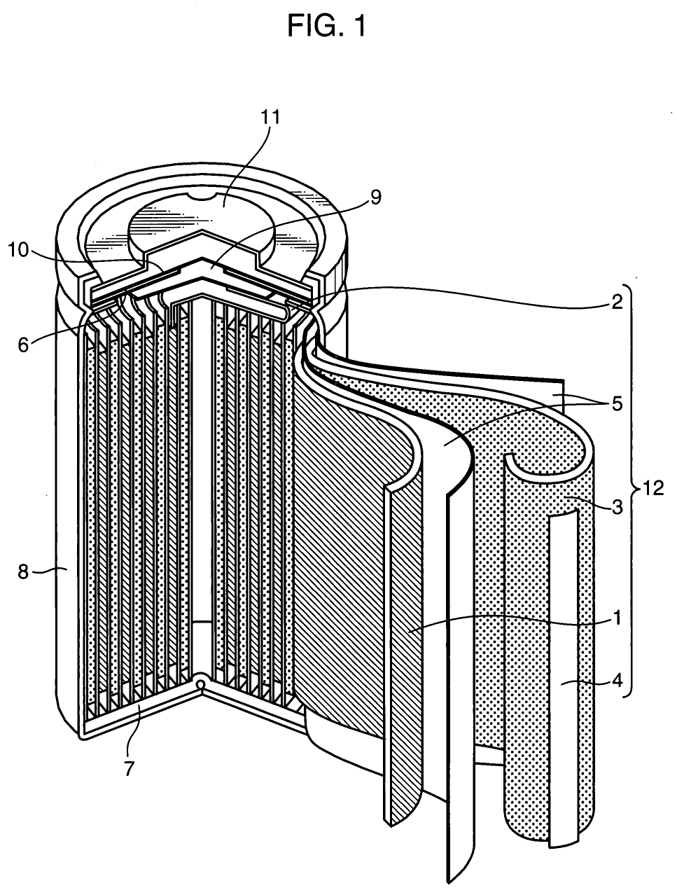

FIG. 1 is a schematic sectional view illustrating the nonaqueous electrolyte secondary battery having the electrode assembly in the wound structure. The electrode assembly 12 has a structure in which a positive electrode 1 connected to a positive electrode lead 2 and a negative electrode 3 connected to a negative electrode lead 4 are wound, as separated by a separator 5, in the spiral form. A top insulation plate 6 is placed on the top of the electrode plates 12 and a bottom insulation plate 7 under the bottom. And, a case 8 containing the electrode assembly 12 and a nonaqueous electrolyte solution (not shown in the Figure) is sealed with a sealing plate 10 having a gasket 9 and a positive electrode terminal 11.

In production of the nonaqueous electrolyte secondary battery, it is preferable to have a high-voltage-charging step of charging to a voltage in the range of 4.3 to 4.5 V at least once after the above assembling step. By charging the nonaqueous electrolyte secondary battery up to the high voltage of 4.3 to 4.5 V, it is possible to sufficiently ensure the improvement in discharge rate characteristics and high-temperature storage characteristics by the additives (A) and (B), because the additive (B) forms a film preferentially on the negative electrode surface and the additive (A) mainly on the positive electrode surface. It is preferable to charge to a voltage in the range of 4.3 to 4.5 V at least once in the high-voltage-charging step, but more preferable to charge at least twice in order to form the films on both electrode surfaces more favorable for high-temperature storage characteristics. On the other hand, the high-voltage charging is preferably performed 10 times or less, more preferably 5 times or less, from the viewpoint of productivity. When charging is performed twice or more, an end voltage of discharge is not particularly limited, but preferably 3.0 V or more, for prevention of overdischarge. A charge voltage in the high-voltage-charging step at higher than 4.5 V may lead to significant elution of metal ions from the positive electrode and significant decomposition of both additives, making it difficult to form a uniform film.

It is thus preferable to place a preliminary charging/discharging step of performing a charge/discharge cycle of charging to an end voltage of preliminary charge of lower than 4.3 V and discharging to an end voltage of preliminary discharge of 3.0 V or higher at least once after the assembling step and before the high-voltage-charging step. The additive (A) is adsorbed and decomposed on the positive electrode surface, forming a film at a high voltage of 4.3 V or more, while the additive (B) forms a film on the negative electrode surface more preferentially than the additive (A) even at a low voltage. Accordingly, it is possible to form a film preferentially on the negative electrode surface with the additive (B), by previously charging/discharging the battery at a low voltage at which the additive (A) is not adsorbed or decomposed on the positive electrode surface. By charging the battery at the high voltage after preliminary formation of the film by the additive (B) on the area of the negative electrode surface interacting with the additive (A) by the preliminary charging at the low voltage, it is possible to further improve the high-temperature storage characteristics, because the film by the additive (A) is formed on the positive electrode surface. The charge/discharge cycle is preferably carried out at least once, but preferably at least thrice, for forming a film favorable in high-temperature storage characteristics. On the other hand, the charge/discharge cycle is preferably carried out ten times or less, more preferably five times or less, from the viewpoint of productivity. The end voltage of preliminary charge is not particularly limited, if it is lower than 4.3 V, but it is preferably 3.8 V or higher, more preferably 3.9 V to 4.1 V. The end voltage of preliminary discharge is not particularly limited, if it is 3.0 V or higher, but preferably 3.6 V or lower, more preferably 3.0 to 3.4 V.

The nonaqueous electrolyte secondary battery thus produced is used normally at an end voltage of charge in the range of 4.3 to 4.5 V. An end voltage of charge of lower than 4.3 V, which is rather low voltage, prevents deterioration in discharge capacity when stored at high temperature in the charged state, but there is no use in using the positive electrode active material compatible with high voltage that has high capacity and is superior in discharge rate characteristics. In addition, use only at an end voltage of charge in the range of 4.3 V or lower without a high-voltage-charging step results significantly only in deterioration in discharge rate characteristics, because the additive (A) cannot form a film sufficiently on the positive electrode surface. On the other hand, an end voltage of charge of higher than 4.5 V leads to significant elution of metal ions from the positive electrode when a positive electrode active material compatible with high voltage is used, prohibiting improvement in high-temperature storage characteristics even when the additives (A) and (B) are used in combination. The end voltage of charge is a voltage per unit cell battery. In the case of an assembled battery consisting of multiple cells, it means a voltage assigned to each unit cell. Alternatively, the end voltage of charge is a voltage set for normal use of the device in which the battery is used, and does not mean a voltage during abnormal use, for example during overcharge.

Constant-current and constant-voltage charging is preferable for charging during the use above. Specifically, the battery is preferably charged under constant current until an end voltage of charge of 4.3 to 4.5 V, and then, under constant voltage in the range of 4.3 to 4.5 V.

The nonaqueous electrolyte secondary battery according to the present embodiment is applicable to batteries in any shape or size including small batteries of coin type, button-type, sheet-type, laminate-type, cylindrical, flat, and square batteries and large batteries such as those used in electric vehicle. The nonaqueous electrolyte secondary battery according to the present embodiment is also used in applications such as portable information system, personal digital assistant, portable electronic device, domestic small power storage device, bike, electric vehicle and hybrid electric vehicle, but the applications are not limited thereto.

In the present invention described so far in details, all description is provided here only to illustrate the present invention by embodiments in all aspects, and thus the present invention is not limited thereto. It should be understood that numerous modifications not exemplified here are also possible without departing from the scope of the present invention.

Hereinafter, the present invention will be described with reference to Examples, but it should be understood that the present invention is not limited by these Examples.

### EXAMPLES

### Example 1

### Example 1-1

### Positive Electrode

The transition metal-containing composite oxide represented by the compositional formula Li_{1.05}Ni_{1/3}Co_{1/3}Mn_{1/3}O₂ prepared by the following method was used as the positive electrode active material.

Sulfate salts of Co and Mn were added to an aqueous NiSO₄ solution at a particular rate, to give a saturated aqueous solution. An alkaline solution containing sodium hydroxide was added dropwise while the saturated aqueous solution was stirred at low speed, to give a precipitate of a ternary hydroxide Ni_{1/3}Co_{1/3}Mn_{1/3}(OH)₂ by coprecipitation. The precipitate was filtered, washed with water, and dried in air at 80° C. The average diameter of the hydroxide obtained was approximately 10 μm.

Then, the hydroxide obtained was heated in air at 380° C. for 10 hours (hereinafter, referred to as primary sintering), to give a ternary oxide Ni_{1/3}Co_{1/3}Mn_{1/3}O. Analysis of the oxide obtained by powder X-ray diffraction showed that the oxide was in a single phase.

Lithium hydroxide monohydrate was added to the oxide thus obtained to a ratio of the sum of the molar numbers of Ni, Co, and Mn to that of Li at 1.00:1.05, and the mixture was sintered in air at 1,000° C. for 10 hours (hereinafter, referred to as secondary sintering), to give desirable Li_{1.05}Ni_{1/3}Co_{1/3}Mn_{1/3}O₂. Powder X-ray diffraction analysis of the transition metal-containing composite oxide obtained showed that it has a single-phase hexagonal layered structure wherein Co and Mn are present as solid solution. Subsequent pulverization and classification thereof gave a positive electrode active material powder [average diameter: 8.5 μm, specific surface area as determined by BET method (hereinafter, referred to simply as specific surface area): 0.15 m²/g].

Observation under a scanning electron microscope showed that the positive electrode active material powder contained almost spherical to elliptical secondary particles, aggregates of many primary particles, of about 0.1 to 1.0 μm in size.

2.5 parts by mass of AB as a conductive substance was added to 100 parts by mass of the positive electrode active material thus obtained. The mixture was blended with a solution of a binder PVDF in N-methylpyrrolidone (NMP) solvent, to give a paste. PVDF was added in an amount adjusted to 2 parts by mass with respect to 100 parts by mass of the active material. Then, the paste was coated, dried, and pressed on both faces of an aluminum foil, to give a positive electrode having an active material density of 3.30 g/cc, a thickness of 0.152 mm, a mixture width of 56.5 mm, and a length of 520 mm.

### <Negative Electrode>

Synthetic graphite was used as the negative electrode active material. A paste containing the synthetic graphite, SBR, and an aqueous CMC solution at a mass ratio with synthetic graphite: SBR: CMC of 100:1:1 was prepared. The paste was coated, dried, and pressed on both faces of a copper foil, to give a negative electrode having an active material density of 1.60 g/cc, a thickness of 0.174 mm, a mixture width of 58.5 mm, and a length of 580 mm.

In preparation of the negative electrode, the amount of the negative electrode active material was so adjusted that, per unit volume of the area where the positive and negative electrode mixture layers are facing each other, the ratio of the mass of negative electrode active material to the mass of positive electrode active material is 0.61 and the load capacity is 300 mAh/g when the end voltage of charge is set to 4.4 V.

### <Nonaqueous Electrolyte Solution>

The nonaqueous electrolyte solution was prepared by dissolving lithium hexafluorophosphate (LiPF₆) in a solvent of EC, DMC, and EMC at a volume rate of 20:60:20 to a concentration of 1.0 mol/L and adding PRS as an additive (A) to 1 mass % and LiBF₄ as an additive (B) to 1 mass %.

### <Nonaqueous Electrolyte Secondary Battery>

A positive-electrode aluminum lead and a negative-electrode nickel lead were connected respectively to the positive and negative electrodes, after part of the respective mixture layers were removed. An electrode assembly were prepared by winding spirally the positive and negative electrodes, as they were separated by a separator made of PP and PE. A PP top insulation plate was placed on the top of the electrode assembly and a PP bottom insulation plate under the bottom of the electrode assembly, and the composite was placed in a case of nickel-plated iron having a diameter of 18 mm and a height of 65 mm. After the nonaqueous electrolyte solution prepared above was poured into the case, the opening was sealed with a sealing plate, to give a nonaqueous electrolyte secondary battery of Example 1-1 (theoretical capacity at an end voltage of charge of 4.4 V: 2,350 mAh).

### Example 1-2

A nonaqueous electrolyte secondary battery of Example 1-2 was prepared in a similar manner to Example 1-1, except that the additive (B) LiBF₄ used in Example 1-1 was replaced with MA.

### Example 1-3

A nonaqueous electrolyte secondary battery of Example 1-3 was prepared in a similar manner to Example 1-1, except that the additive (B) LiBF₄ used in Example 1-1 was replaced with VC.

### Example 1-4

A nonaqueous electrolyte secondary battery of Example 1-4 was prepared in a similar manner to Example 1-1, except that the additive (B) LiBF₄ used in Example 1-1 was replaced with VEC.

### Example 1-5

A nonaqueous electrolyte secondary battery of Example 1-5 was prepared in a similar manner to Example 1-1, except that 1 mass % of MA as an additive (B) was added additionally in Example 1-1.

### Example 1-6

A nonaqueous electrolyte secondary battery of Example 1-6 was prepared in a similar manner to Example 1-1, except that the additive (A) PRS used in Example 1-1 was replaced with ES.

### Example 1-7

A nonaqueous electrolyte secondary battery of Example 1-7 was prepared in a similar manner to Example 1-1, except that the additive (A) PRS used in Example 1-1 was replaced with PS.

### Comparative Example 1

A nonaqueous electrolyte secondary battery of Comparative Example 1 was prepared in a similar manner to Example 1-1, except that the additive (A) PRS of Example 1-1 was used in an amount of 2 mass % and the additive (B) was not used.

### Comparative Example 2

A nonaqueous electrolyte secondary battery of Comparative Example 2 was prepared in a similar manner to Example 1-1, except that the additive (B) LiBF₄ of Example 1-1 was used in an amount of 2 mass % and the additive (A) was not used.

### <Initial Charge and Discharge>

Each of the nonaqueous electrolyte secondary batteries was subjected to initial charge and discharge consisting of each step of preliminary charging/discharging, aging, and high-voltage-charging. In the preliminary charging/discharging step, each nonaqueous electrolyte secondary battery was subjected to three charge/discharge cycles of charging to an end voltage of preliminary charge of 4.1 V at a constant current of 480 mA and discharging to an end voltage of preliminary discharge of 3.0 V at a constant current of 480 mA under an environment at 20° C. Then, in the aging step, each nonaqueous electrolyte secondary battery was charged to 4.1 V at a constant current of 480 mA under an environment at 20° C., left under an environment at 60° C. for two days, and then, discharged to 3.0 V at a constant current of 480 mA under an environment at 20° C. In the high-voltage-charging step, each nonaqueous electrolyte secondary battery was subjected to two charge/discharge cycles of charging to 4.4 V at a constant current of 1,680 mA under an environment at 20° C., charging at a constant voltage of 4.4 V until the charge current declines to 120 mA, and discharging to 3.0 V at a constant current of 480 mA.

### Example 1-8

A nonaqueous electrolyte secondary battery of Example 1-8 was prepared in a similar manner to Example 1-1, except that, during the initial charge and discharge above, the preliminary charging/discharging and aging were performed and the charge/discharge cycle of high-voltage-charging was performed only once with the nonaqueous electrolyte secondary battery prepared in Example 1-1.

### Example 1-9

A nonaqueous electrolyte secondary battery of Example 1-9 was prepared in a similar manner to Example 1-1, except that, during the initial charge and discharge, the preliminary charging/discharging was not performed and only the aging and high-voltage-charging were performed with the nonaqueous electrolyte secondary battery prepared in Example 1-1.

### Example 1-10

A nonaqueous electrolyte secondary battery of Example 1-10 was prepared in a similar manner to Example 1-1, except that, during the initial charge and discharge, the preliminary charging/discharging and aging were performed but the high-voltage-charging was not performed with the nonaqueous electrolyte secondary battery prepared in Example 1-1.

Each of the nonaqueous electrolyte secondary batteries was examined in the tests shown below. The results are summarized in Table 1.

### (Discharge Rate Test)

Each nonaqueous electrolyte secondary battery was charged to 4.4 V at a constant current of 1,680 mA under an environment at 20° C., charged at a constant voltage of 4.4 V until the charge current declined to 120 mA, and discharged to 3.0 V at a constant current of 4,800 mA. The ratio of the discharge capacity at this time to the discharge capacity after second-cycle charge in the high-voltage-charging step was evaluated as the discharge rate characteristics. As for Example 1-8, it was a value with respect to the discharge capacity after first-cycle charge in the high-voltage-charging step. Alternatively as for Example 1-10, it was a value with respect to the discharge capacity after the second-cycle charge in the high-voltage-charging step of Example 1-1.

### (High-Temperature Storage Test)

Each nonaqueous electrolyte secondary battery was charged to 4.4 V at a constant current of 1,680 mA under an environment at 20° C., charged at a constant voltage of 4.4 V until the charge current declined to 120 mA, and stored as it was in the charged state under an environment at 60° C. for 20 days. The battery after storage was discharged at a constant current of 480 mA, charged to 4.4 V at a constant current of 1,680 mA under an environment at 20° C., charged at a constant voltage of 4.4 V until the charge current declined to 120 mA, and discharged to 3.0 V at a constant current of 480 mA. The ratio of the discharge capacity at this time to the second-cycle discharge capacity in the high-voltage-charging step was evaluated as the high-temperature storage characteristics. As for Example 1-8, it was a value with respect to the discharge capacity after first-cycle charge in the high-voltage-charging step. Alternatively as for Example 1-10, it was a value with respect to the discharge capacity after second-cycle charge in the high-voltage-charging step of Example 1-1.

TABLE 1

| | | Preliminary | | End voltage | Discharge rate | High-temperature |
|---|---|---|---|---|---|---|
| | | charging/ | High-voltage | of charge | characteristics | storage |
| Battery | Additive | discharging | charging | (V) | (%) | characteristics (%) |
| Example 1-1 | A: PRS (1 mass %) | yes | yes | 4.4 | 92 | 90 |
| | B: LiBF₄ (1 mass %) | | | | | |
| Example 1-2 | A: PRS (1 mass %) | yes | yes | 4.4 | 92 | 90 |
| | B: MA (1 mass %) | | | | | |
| Example 1-3 | A: PRS (1 mass %) | yes | yes | 4.4 | 92 | 90 |
| | B: VC (1 mass %) | | | | | |
| Example 1-4 | A: PRS (1 mass %) | yes | yes | 4.4 | 91 | 90 |
| | B: VEC (1 mass %) | | | | | |
| Example 1-5 | A: PRS (1 mass %) | yes | yes | 4.4 | 90 | 91 |
| | B: LiBF₄ (1 mass %) | | | | | |
| | MA (1 mass %) | | | | | |
| Example 1-6 | A: ES (1 mass %) | yes | yes | 4.4 | 92 | 90 |
| | B: LiBF₄ (1 mass %) | | | | | |
| Example 1-7 | A: PS (1 mass %) | yes | yes | 4.4 | 92 | 90 |
| | B: LiBF₄ (1 mass %) | | | | | |
| Example 1-8 | A: PRS (1 mass %) | yes | yes | 4.4 | 90 | 89 |
| | B: LiBF₄ (1 mass %) | | | | | |
| Example 1-9 | A: PRS (1 mass %) | no | yes | 4.4 | 89 | 85 |
| | B: LiBF₄ (1 mass %) | | | | | |
| Example 1-10 | A: PRS (1 mass %) | yes | no | 4.4 | 88 | 84 |
| | B: LiBF₄ (1 mass %) | | | | | |
| Comparative | A: PRS (2 mass %) | yes | yes | 4.4 | 92 | 75 |
| Example 1 | B: none | | | | | |
| Comparative | A: none | yes | yes | 4.4 | 92 | 74 |
| Example 2 | B: LiBF₄ (2 mass %) | | | | | |

As apparent from the results in Table 1, even when the high end voltage of charge of 4.4 V is used while the positive electrode active material compatible with high voltage is used, the nonaqueous electrolyte secondary batteries employing the nonaqueous electrolyte solution containing both the additives (A) and (B) were superior both in discharge rate characteristics and high-temperature storage characteristics. In contrast, the nonaqueous electrolyte secondary battery of Comparative Example 1 or 2 employing the nonaqueous electrolyte solution containing only the additive (A) or (B) is unsatisfactory in high-temperature storage characteristics, while discharge rate characteristics is equivalent to that of the Examples, because the positive electrode active material compatible with high voltage was used. It seems that presence of only the additive (A) or (B) in the nonaqueous electrolyte solution prohibited sufficient formation on the positive electrode surface of a film for controlling elution of metal ions from the positive electrode when the end voltage of charge was set to the high voltage of 4.4 V, and thus, lead to precipitation of the metal ions on the negative electrode surface.

In addition, the nonaqueous electrolyte secondary batteries in Examples 1-1 to 1-8 were processed both in the preliminary charging/discharging step and the high-voltage-charging step after the assembling step, and thus, were superior in high-temperature storage characteristics to the nonaqueous electrolyte secondary batteries of Examples 1-9 to 1-10 which were processed only in one of the steps.

The results above indicate that it is possible to prepare the nonaqueous electrolyte secondary battery superior both in discharge rate characteristics and high-temperature storage characteristics by using the transition metal-containing composite oxide compatible with high voltage as the positive electrode active material and the nonaqueous electrolyte solution containing at least one additive (A) selected from the group consisting of ES, PRS, and PS and at least one additive (B) selected from the group consisting of MA, VC, VEC, and LiBF₄, for utilizing the high end voltage of charge. The nonaqueous electrolyte secondary battery has discharge rate characteristics and high-temperature storage characteristics both at high level, by the preliminary charging/discharging and high-voltage charging after assembling the battery.

### Example 2

Then, the relationship between the load capacity and the battery characteristics of the nonaqueous electrolyte secondary batteries employing the nonaqueous electrolyte solution containing the additives (A) and (B) was studied.

### Example 2-1

The length of the positive electrode of Example 1-1 was adjusted to 470 mm. The mass per unit area of the negative electrode active material coated on both faces of the copper foil was so adjusted as to make the load capacity 250 mAh/g (thickness of the negative electrode: 0.214 mm, and length of the negative electrode: 530 mm). A nonaqueous electrolyte secondary battery of Example 2-1 was prepared in a similar manner to Example 1-1, except the conditions above.

### Example 2-2

The length of the positive electrode of Example 1-1 was adjusted to 560 mm. The mass per unit area of the negative electrode active material coated on both faces of the copper foil was so adjusted as to make the load capacity 360 mAh/g (thickness of the negative electrode: 0.151 mm, and length of the negative electrode: 620 mm). A nonaqueous electrolyte secondary battery of Example 2-2 was prepared in a similar manner to Example 1-1, except the conditions above.

### Example 2-3

The length of the positive electrode of Example 1-1 was adjusted to 460 mm. The mass per unit area of the negative electrode active material coated on both faces of the copper foil was so adjusted as to make the load capacity 240 mAh/g (thickness of the negative electrode: 0.222 mm, and length of the negative electrode: 520 mm). A nonaqueous electrolyte secondary battery of Example 2-3 was prepared in a similar manner to Example 1-1, except the conditions above.

### Example 2-4

The length of the positive electrode of Example 1-1 was adjusted to 570 mm. The mass per unit area of the negative electrode active material coated on both faces of the copper foil was so adjusted as to make the load capacity 370 mAh/g (thickness of the negative electrode: 0.148 mm, and length of the negative electrode: 630 mm). A nonaqueous electrolyte secondary battery of Example 2-4 was prepared in a similar manner to Example 1-1, except the conditions above.

Each of the nonaqueous electrolyte secondary batteries was subjected to the initial charge and discharge under the same condition as that in Example 1, and the discharge rate test and the high-temperature storage test were performed under the same condition as that in Example 1. The results are summarized in Table 2.

TABLE 2

| | | | Discharge | High-temperature |
|---|---|---|---|---|
| | Load | End | rate | storage |
| | capacity | voltage of | characteristics | characteristics |
| Battery | (mAh/g) | charge (V) | (%) | (%) |
| Example 2-3 | 240 | 4.4 | 83 | 84 |
| Example 2-1 | 250 | 4.4 | 87 | 91 |
| Example 1-1 | 300 | 4.4 | 92 | 90 |
| Example 2-2 | 360 | 4.4 | 92 | 87 |
| Example 2-4 | 370 | 4.4 | 91 | 84 |

As shown in Table 2, the nonaqueous electrolyte secondary battery in any Example is superior both in discharge rate characteristics and high-temperature storage characteristics. Among these Examples, the nonaqueous electrolyte secondary battery of Example 2-3, which has the load capacity of less than 250 mAh/g, causes deterioration in polarization characteristics because of the increase in the amount of lithium ions liberated per unit area along shortening of the electrode plate length, showing faster deterioration in discharge rate characteristics compared to that of the nonaqueous electrolyte secondary batteries of other Examples. It also shows a tendency that the high-temperature storage characteristics decreases along with increase of the rate of the amount of the electrolyte solution to the electrode plate area. On the other hand, the nonaqueous electrolyte secondary battery of Example 2-4, which has the load capacity of more than 370 mAh/g, shows a tendency to deteriorate in high-temperature storage characteristics, because of the inactivation by reaction of the lithium not intercalated into the layers of graphite with the electrolyte solution during charging. The results above indicate that the load capacity is preferably in the range of 250 to 360 mAh/g when a carbon material is used as the negative electrode active material.

### Example 3

Then, the relationship between the end voltage of charge and the battery characteristics of nonaqueous electrolyte secondary batteries employing the nonaqueous electrolyte solution containing the additives (A) and (B) was studied.

### Example 3-1

The length of the positive electrode of Example 1-1 was adjusted to 540 mm. The mass per unit area of the negative electrode active material coated on both faces of the copper foil was so adjusted as to make the load capacity 300 mAh/g when the end voltage of charge was set to 4.3 V (thickness of the negative electrode: 0.164 mm, and length of the negative electrode: 600 mm). A nonaqueous electrolyte secondary battery of Example 3-1 was prepared in a similar manner to Example 1-1, except the conditions above.

### Example 3-2

The length of the positive electrode of Example 1-1 was adjusted to 510 mm. The mass per unit area of the negative electrode active material coated on both faces of the copper foil was so adjusted as to make the load capacity 300 mAh/g when the end voltage of charge was set to 4.5 V (thickness of the negative electrode: 0.180 mm, and length of the negative electrode: 570 mm). A nonaqueous electrolyte secondary battery of Example 3-2 was prepared in a similar manner to Example 1-1, except the conditions above.

### Comparative Example 3

The length of the positive electrode of Example 1-1 was adjusted to 560 mm. The mass per unit area of the negative electrode active material coated on both faces of the copper foil was so adjusted as to make the load capacity 300 mAh/g when the end voltage of charge was set to 4.2 V (thickness of the negative electrode: 0.152 mm, and length of the negative electrode: 620 mm). A nonaqueous electrolyte secondary battery of Comparative Example 3 was prepared in a similar manner to Example 1-1, except the conditions above.

### Comparative Example 4

The length of the positive electrode of Example 1-1 was adjusted to 500 mm. The mass per unit area of the negative electrode active material coated on both faces of the copper foil was so adjusted as to make the load capacity 300 mAh/g when the end voltage of charge was set to 4.6 V (thickness of the negative electrode: 0.185 mm, and length of the negative electrode: 560 mm). A nonaqueous electrolyte secondary battery of Comparative Example 4 was prepared in a similar manner to Example 1-1, except the conditions above.

### Comparative Examples 5 and 9

Nonaqueous electrolyte secondary batteries of Comparative Examples 5 and 9 were prepared in a similar manner to Comparative Example 3, except that the electrolyte solution composition used in Comparative Examples 1 and 2 was used as the electrolyte solution composition (including the additives) in Comparative Example 3.

### Comparative Examples 6 and 10

Nonaqueous electrolyte secondary batteries of Comparative Examples 6 and were prepared in a similar manner to Example 3-1, except that the electrolyte solution composition used in Comparative Examples 1 and 2 was used as the electrolyte solution composition (including the additives) in Example 3-1.

### Comparative Examples 7 and 11

Nonaqueous electrolyte secondary batteries of Comparative Examples 7 and were prepared in a similar manner to Example 3-2, except that the electrolyte solution composition used in Comparative Examples 1 and 2 was used as the electrolyte solution composition (including the additives) in Example 3-2.

### Comparative Example 8 and 12

Nonaqueous electrolyte secondary batteries of Comparative Examples 8 and were prepared in a similar manner to Comparative Example 4, except that the electrolyte solution composition used in Comparative Examples 1 and 2 was used as the electrolyte solution composition (including the additives) in Comparative Example 4.

Each of the nonaqueous electrolyte secondary batteries was processed in the preliminary charging/discharging and aging steps under the same conditions as those during the initial charge and discharge in Example 1. Then, two cycles of charge and discharge were performed similarly to Example 1, except that the upper limit of the charge voltage in the high-voltage-charging step was set to the end voltage of charge shown in Table 3. The discharge capacity in the 2nd cycle represents the initial capacity. Then, each of the nonaqueous electrolyte secondary batteries above was subjected to the discharge rate test and the high-temperature storage test in a similar manner to Example 1. The end voltage of charge and the charge voltage during storage at high temperature in each test were set to the values of end voltage of charge shown in Table 3. The results are summarized in Table 3.

TABLE 3

| | | | | Discharge rate | High-temperature |
|---|---|---|---|---|---|
| | | End voltage of | Initial capacity | characteristics | storage characteristics |
| Battery | Additive | charge (V) | (mAh) | (%) | (%) |
| Comparative Example 3 | A: PRS | 4.2 | 2200 | 87 | 92 |
| Example 3-1 | (1 mass %) | 4.3 | 2305 | 90 | 91 |
| Example 1-1 | B: LiBF₄ | 4.4 | 2355 | 92 | 90 |
| Example 3-2 | (1 mass %) | 4.5 | 2400 | 91 | 88 |
| Comparative Example 4 | | 4.6 | 2430 | 91 | 67 |
| Comparative Example 5 | A: PRS | 4.2 | 2200 | 91 | 91 |
| Comparative Example 6 | (2 mass %) | 4.3 | 2305 | 91 | 78 |
| Comparative Example 1 | B: none | 4.4 | 2355 | 92 | 75 |
| Comparative Example 7 | | 4.5 | 2400 | 92 | 71 |
| Comparative Example 8 | | 4.6 | 2430 | 91 | 65 |
| Comparative Example 9 | A: none | 4.2 | 2200 | 91 | 91 |
| Comparative Example 10 | B: LiBF₄ | 4.3 | 2305 | 91 | 77 |
| Comparative Example 2 | (2 mass %) | 4.4 | 2355 | 92 | 74 |
| Comparative Example 11 | | 4.5 | 2400 | 91 | 71 |
| Comparative Example 12 | | 4.6 | 2430 | 90 | 64 |

As apparent from Table 3, the nonaqueous electrolyte secondary batteries of Examples 1-1, 3-1 and 3-2, in which the end voltage of charge in the range of 4.3 to 4.5 V was applied in the high-voltage-charging step and in the discharge rate test, utilize the favorable properties of the positive electrode active material compatible with high voltage sufficiently and show high initial capacity. The batteries are also superior in high-temperature storage characteristics even when stored in the charged state at the high voltage of 4.3 to 4.5 V at high temperature, because the range of the end voltage of charge is a range of voltage allowing the additive (B) to form a film on the negative electrode surface and the additive (A) on the positive electrode surface. Thus, it is confirmed that the nonaqueous electrolyte secondary battery well-balanced in initial capacity, discharge rate characteristics, and high-temperature storage characteristics can be obtained by using the end voltage of charge above.

In contrast, the nonaqueous electrolyte secondary battery of Comparative Example 4, which had the end voltage of charge of more than 4.5 V, showed deterioration in high-temperature storage characteristics, even though both additives (A) and (B) were added to the nonaqueous electrolyte solution. Apparently, the storage characteristics was decreased, because elution of metal ions from the positive electrode active material compatible with high voltage became more vigorous at the end voltage of charge of higher than 4.5 V, and the additives (A) and (B) were not effective enough to prevent increase of impedance. The nonaqueous electrolyte secondary battery of Comparative Example 3, which had the end voltage of charge of less than 4.3 V, showed the distinctively lowered initial capacity because it was not possible to use the high-voltage positive electrode active material effectively, although a high-temperature storage characteristics was not decreased because the low end voltage of charge was used. It also showed the discharge rate characteristics lower than that of the Comparative Example 5 or 9 in which only an additive (A) or (B) was added to the nonaqueous electrolyte solution. It seems that the additive (A) did not form a film sufficiently on the positive electrode because the end voltage of charge was low, leading to increase in impedance of the internal battery. The results above indicate that it is possible to prepare a high-capacity nonaqueous electrolyte secondary battery superior in discharge rate characteristics and high-temperature storage characteristics by using the end voltage of charge in the range of 4.3 to 4.5 V. The results also show that the charge voltage in the high-voltage-charging step is preferably in the range of 4.3 to 4.5 V.

### Example 4

Then, the relationship between the addition amount of the additives (A) and (B) and the battery characteristics of the nonaqueous electrolyte secondary batteries employing a nonaqueous electrolyte solution containing the additives (A) and (B) was studied.

### Examples 4-1 to 4-7

Nonaqueous electrolyte secondary batteries of Examples 4-1 to 4-7 were prepared in a similar manner to Example 1-1, except that the nonaqueous electrolyte solution containing the additives (A) and (B) in the amounts shown in Table 4 was used in Example 1-1.

Each of the nonaqueous electrolyte secondary batteries above was subjected to the initial charge and discharge under the same condition as that in Example 1 and then, to the discharge rate test and the high-temperature storage test under the same condition as that in Example 1. The results are summarized in Table 4.

TABLE 4

| | | | High-temperature |
|---|---|---|---|
| | | Discharge rate | storage |
| | | characteristics | characteristics |
| Battery | Additive | (%) | (%) |
| Example 4-1 | A: PRS (0.03 mass %) | 94 | 82 |
| | B: LiBF₄ (0.03 | | |
| | mass %) | | |
| Example 4-2 | A: PRS (0.05 mass %) | 93 | 87 |
| | B: LiBF₄ (0.05 | | |
| | mass %) | | |
| Example 1-1 | A: PRS (1 mass %) | 92 | 90 |
| | B: LiBF₄ (1 mass %) | | |
| Example 4-3 | A: PRS (2 mass %) | 92 | 91 |
| | B: LiBF₄ (2 mass %) | | |
| Example 4-4 | A: PRS (4 mass %) | 88 | 93 |
| | B: LiBF₄ (4 mass %) | | |
| Example 4-5 | A: PRS (5 mass %) | 82 | 94 |
| | B: LiBF₄ (5 mass %) | | |
| Example 4-6 | A: PRS (2 mass %) | 92 | 90 |
| | B: LiBF₄ (0.7 mass %) | | |
| Example 4-7 | A: PRS (0.7 mass %) | 92 | 89 |
| | B: LiBF₄ (2 mass %) | | |

As shown in Table 4, the nonaqueous electrolyte secondary battery in any Example was superior both in discharge rate characteristics and high-temperature storage characteristics. Among these Examples, the nonaqueous electrolyte secondary battery of Example 4-1, which contained the additives (A) and (B) in a total amount of less than 0.1 mass % in the nonaqueous electrolyte solution, showed a tendency to deteriorate in high-temperature storage characteristics. On the other hand, the nonaqueous electrolyte secondary battery of Example 4-5, which contains the additives (A) and (B) in a total amount of more than 8 mass % in the nonaqueous electrolyte solution, showed a tendency to decrease in discharge rate characteristics. The results above indicate that the total amount of the additives (A) and (B) in the nonaqueous electrolyte solution is preferably 0.1 to 10 mass %, more preferably 0.1 to 8 mass %, and still more preferably 0.1 to 4 mass %.

### Example 5

Then, the relationship between the specific surface area of the positive electrode active material and the battery characteristics of the nonaqueous electrolyte secondary batteries employing the nonaqueous electrolyte solution containing the additives (A) and (B) was studied.

### Examples 5-1 to 5-3

Nonaqueous electrolyte secondary batteries of Examples 5-1 to 5-3 were prepared in a similar manner to Example 1-1, except that Li_{1.05}Ni_{1/3}Co_{1/3}Mn_{1/3}O₂ having a specific surface area of 0.12, 1.50, or 2.00 m²/g, which was prepared by using the temperatures shown in Table 5 as the primary and secondary sintering temperatures in the positive electrode active material-producing process, was used as the positive electrode active material in Example 1-1.

Each of the nonaqueous electrolyte secondary batteries above was subjected to the initial charge and discharge under the same condition as that in Example 1 and then, to the discharge rate test and the high-temperature storage test under the same condition as that in Example 1. The results are summarized in Table 5.

TABLE 5

| | Primary | Secondary | | | |
|---|---|---|---|---|---|
| | sintering | sintering | Specific | Discharge rate | High-temperature |
| | temperature | temperature | surface area | characteristics | storage characteristics |
| Battery | (° C.) | (° C.) | (m²/g) | (%) | (%) |
| Example 5-1 | 380 | 1050 | 0.12 | 88 | 91 |
| Example 1-1 | 380 | 1000 | 0.15 | 92 | 90 |
| Example 5-2 | 120 | 800 | 1.50 | 93 | 88 |
| Example 5-3 | 120 | 750 | 2.00 | 94 | 82 |

As shown in Table 5, the nonaqueous electrolyte secondary battery in any Example was superior both in discharge rate characteristics and high-temperature storage characteristics. Among these Examples, the nonaqueous electrolyte secondary battery of Example 5-3 employing the positive electrode active material having a specific surface area of more than 1.50 m²/g, which raises elution of the metal ions along with increase of the surface area (reaction area) of the active material, shows a tendency to deteriorate in high-temperature storage characteristics. On the other hand, the nonaqueous electrolyte secondary battery of Example 5-1 employing the positive electrode active material having a specific surface area of less than 0.15 m²/g, which lowers battery reaction along with decrease of the surface area of the active material, shows a tendency to deteriorate in discharge rate characteristics. The results above indicate that the specific surface area of the positive electrode active material is preferably 0.15 to 1.50 m²/g.

### Example 6

Then, the relationship between the composition of the positive electrode active material and the battery characteristics of the nonaqueous electrolyte secondary batteries employing the nonaqueous electrolyte solution containing the additives (A) and (B) was studied.

### Examples 6-1 to 6-4

Positive electrode active materials of Examples 6-1 to 6-4 were prepared in a similar manner to Example 1-1, except that, in preparation of the positive electrode active material of Example 1-1, lithium hydroxide monohydrate was added to the ternary oxide Ni_{1/3} Co_{1/3} Mn_{1/3} O at a rate of the sum of the molar numbers of Ni, Co, and Mn to the molar number of Li respectively of 1.00:0.93, 1.00:0.95, 1.00:1.12, and 1.00:1.15. Nonaqueous electrolyte secondary batteries of Examples 6-1 to 6-4 were prepared in a similar manner to Example 1-1, except that these positive electrode active materials were used. The specific surface areas of the positive electrode active materials were respectively, 0.53 m²/g (Example 6-1), 0.40 m²/g (Example 6-2), 0.20 m²/g (Example 6-3), and 0.17 m²/g (Example 6-4).

### Example 6-5

In preparation of the positive electrode active material of Example 1-1, the sulfate salt of Mn was added to the aqueous NiSO₄ solution at a particular ratio, to give a saturated aqueous solution. The aqueous alkaline solution containing sodium hydroxide was added dropwise to the saturated aqueous solution, to give a binary hydroxide Ni_{0.67}Mn_{0.33}(OH)₂. A positive electrode active material Li_{1.05}Ni_{0.67}Mn_{0.33}O₂ (specific surface area: 0.42 m²/g) was prepared by using the hydroxide obtained as its raw material. A nonaqueous electrolyte secondary battery of Example 6-5 was prepared in a similar manner to Example 1-1, except that this positive electrode active material was used.

### Examples 6-6 to 6-8

In preparation of the positive electrode active material of Example 1-1, the sulfate salts of Co and Mn were added to the aqueous NiSO₄ solution at three different blending ratios, to give respectively saturated aqueous solutions. The alkaline solution containing sodium hydroxide was added to the saturated aqueous solutions, to give ternary hydroxides Ni_{0.67-v}CoᵥMn_{0.33}(OH)₂ (v: 0.01, 0.35, and 0.40). Positive electrode active materials Li_{1.05}Ni_{0.67-v}CoᵥMn_{0.33}O₂ (v: 0.01, 0.35, and 0.40) were prepared by using the hydroxides obtained as raw materials. Nonaqueous electrolyte secondary batteries of Examples 6-6 to 6-8 were prepared in a similar manner to Example 1-1, except that these positive electrode active materials were used. The specific surface areas of the positive electrode active materials were 0.30 m²/g (Example 6-6), 0.30 m²/g (Example 6-7), and 0.32 m²/g (Example 6-8).

### Example 6-9

In preparation of the positive electrode active material of Example 1-1, the sulfate salt of Co was added to the aqueous NiSO₄ solution at a particular ratio, to give a saturated aqueous solution. The aqueous alkaline solution containing sodium hydroxide was added dropwise to the saturated aqueous solution, to give a binary hydroxide Ni_{0.67}Co_{0.33}(OH)₂. A positive electrode active material Li_{1.05}Ni_{0.67}Co_{0.33}O₂ (specific surface area: 0.57 m²/g) was prepared by using the hydroxide obtained as its raw material. A nonaqueous electrolyte secondary battery of Example 6-9 was prepared in a similar manner to Example 1-1, except that this positive electrode active material was used.

### Examples 6-10 to 6-12

In preparation of the positive electrode active material of Example 1-1, the sulfate salts of Co and Mn were added to the aqueous NiSO₄ solution at three different blending ratios, to give respectively saturated aqueous solutions. The alkaline solution containing sodium hydroxide was added to the saturated aqueous solutions, to give a ternary hydroxide Ni_{0.67-w}Co_{0.33}Mn_{w}(OH)₂ (w: 0.01, 0.50, and 0.55). Positive electrode active materials Li_{1.05}Ni_{0.67-w}Co_{0.33}Mn_{w}O₂ (w: 0.01, 0.50, and 0.55) were prepared by using the hydroxide obtained as its raw material. Nonaqueous electrolyte secondary batteries of Examples 6-10 to 6-12 were prepared in a similar manner to Example 1-1, except that these positive electrode active materials were used. The specific surface areas of the positive electrode active materials were 0.30 m²/g (Example 6-10), 0.30 m²/g (Example 6-11), and 0.28 m²/g (Example 6-12).

### Example 6-13

In preparation of the positive electrode active material of Example 1-1, the sulfate salts of Co and Al were added to the aqueous NiSO₄ solution at a particular ratio, to give a saturated aqueous solution. The aqueous alkaline solution containing sodium hydroxide was added dropwise to the saturated aqueous solution, to give a ternary hydroxide Ni_{0.82}Co_{0.15}Al_{0.03}(OH)₂. Sintering the hydroxide obtained, using it as a raw material, in air at 600° C. for 10 hours gave an oxide Ni_{0.82}Co_{0.15}Al_{0.03}O. Then, a positive electrode active material Li_{1.01}Ni_{0.82}Co_{0.15}Al_{0.03}O₂ (specific surface area: 0.30 m²/g) was prepared by adding lithium hydroxide monohydrate to the oxide obtained at a rate of the sum of the molar numbers of Ni, Co, and Al to the molar number of Li of 1.00:1.01 and sintering the mixture in air at 800° C. for 10 hours. A nonaqueous electrolyte secondary battery of Example 6-13 was prepared in a similar manner to Example 1-1, except that this positive electrode active material was used.

### Example 6-14

In preparation of the positive electrode active material of Example 1-1, the sulfate salts of Co and Mn and a nitrate salt of Ti at particular rates were added to the aqueous NiSO₄ solution, to give a saturated aqueous solution. The aqueous alkaline solution containing sodium hydroxide was added dropwise to the saturated aqueous solution, to give a quaternary hydroxide Ni_{0.33}Co_{0.33}Mn_{0.29}Ti_{0.05}(OH)₂. A positive electrode active material Li_{1.05}Ni_{0.33}Co_{0.33}Mn_{0.29}Ti_{0.05}O₂ (specific surface area: 0.33 m²/g) was prepared by using the hydroxide obtained as its raw material. A nonaqueous electrolyte secondary battery of Example 6-14 was prepared in a similar manner to Example 1-1, except that this positive electrode active material was used.

### Examples 6-15 to 6-19

In preparation of the positive electrode active material of Example 1-1, sulfate salts of Co, Mn and M (M represents one of Mg, Mo, Y, Zr and Ca) were added to the aqueous NiSO₄ solution at a particular ratio, to give saturated aqueous solutions. The alkaline solution containing sodium hydroxide was added to the saturated aqueous solutions, to give quaternary hydroxides Ni_{0.33}Co_{0.33}Mn_{0.29}M_{0.05}(OH)₂ (M represents one of Mg, Mo, Y, Zr, and Ca). Positive electrode active materials Li_{1.05}Ni_{0.33}Co_{0.33}Mn_{0.29}M_{0.05}O₂ (M represents one of Mg, Mo, Y, Zr, and Ca) were prepared by using the hydroxide obtained as its raw material. Nonaqueous electrolyte secondary batteries of Examples 6-15 to 6-19 were prepared in a similar manner to Example 1-1, except that these positive electrode active materials were used. The specific surface areas of the positive electrode active materials were all 0.30 m²/g.

Each of the nonaqueous electrolyte secondary batteries above was subjected to the initial charge and discharge under the same condition as that in Example 1 and then, to the discharge rate test and the high-temperature storage test under the same condition as that in Example 1. In addition, the following life test and thermal stability test were performed. Table 6 shows the compositions of the positive electrode active materials obtained in respective Examples, and Table 7 shows the test results.

### (Life Test)

Each nonaqueous electrolyte secondary battery was subjected to 300 charge/discharge cycles of charging to 4.4 V at a constant current of 1,680 mA under an environment at 20° C., charging until the charge current declined to 120 mA at a constant voltage of 4.4 V, and discharging to 3.0 V at a constant current of 480 mA. The ratio of the 300th-cycle discharge capacity to the second-cycle discharge capacity was determined as the capacity retention rate (an indicator of lifetime characteristics).

### (Thermal Stability Test)

Each nonaqueous electrolyte secondary battery was charged to 4.4 V at a constant current of 1,680 mA under an environment at 20° C. and then at a constant voltage of 4.4 V charge until the charge current declined to 120 mA, and a thermocouple was connected to the battery surface. Each battery was placed in a tank under an environment heated at a rate of 5° C./minute and heated to an environment temperature of 150° C. The maximum temperature on the battery surface reached when each nonaqueous electrolyte secondary battery was stored at 150° C. for 2 hours was measured as an indicator of its thermal stability.

TABLE 6

| | Composition of positive electrode active material (metal elements) | | | | | | | | | | |
|---|---|---|---|---|---|---|---|---|---|---|---|
| Battery | Li | Ni | Co | Al | Mn | Ti | Mg | Mo | Y | Zr | Ca |
| Example 6-1 | 0.93 | ⅓ | ⅓ | | ⅓ | | | | | | |
| Example 6-2 | 0.95 | ⅓ | ⅓ | | ⅓ | | | | | | |
| Example 1-1 | 1.05 | ⅓ | ⅓ | | ⅓ | | | | | | |
| Example 6-3 | 1.12 | ⅓ | ⅓ | | ⅓ | | | | | | |
| Example 6-4 | 1.15 | ⅓ | ⅓ | | ⅓ | | | | | | |
| Example 6-5 | 1.05 | 0.67 | | | 0.33 | | | | | | |
| Example 6-6 | 1.05 | 0.66 | 0.01 | | 0.33 | | | | | | |
| Example 6-7 | 1.05 | 0.32 | 0.35 | | 0.33 | | | | | | |
| Example 6-8 | 1.05 | 0.27 | 0.40 | | 0.33 | | | | | | |
| Example 6-9 | 1.05 | 0.67 | 0.33 | | | | | | | | |
| Example 6-10 | 1.05 | 0.66 | 0.33 | | 0.01 | | | | | | |
| Example 6-11 | 1.05 | 0.17 | 0.33 | | 0.50 | | | | | | |
| Example 6-12 | 1.05 | 0.12 | 0.33 | | 0.55 | | | | | | |
| Example 6-13 | 1.01 | 0.82 | 0.15 | 0.03 | | | | | | | |
| Example 6-14 | 1.05 | 0.33 | 0.33 | | 0.29 | 0.05 | | | | | |
| Example 6-15 | 1.05 | 0.33 | 0.33 | | 0.29 | | 0.05 | | | | |
| Example 6-16 | 1.05 | 0.33 | 0.33 | | 0.29 | | | 0.05 | | | |
| Example 6-17 | 1.05 | 0.33 | 0.33 | | 0.29 | | | | 0.05 | | |
| Example 6-18 | 1.05 | 0.33 | 0.33 | | 0.29 | | | | | 0.05 | |
| Example 6-19 | 1.05 | 0.33 | 0.33 | | 0.29 | | | | | | 0.05 |

TABLE 7

| | | | | High- |
|---|---|---|---|---|
| | | | | temperature |
| | Capacity | Thermal | Discharge rate | storage |
| | retention rate | stability | characteristics | characteristics |
| Battery | (%) | (° C.) | (%) | (%) |
| Example 6-1 | 72 | 156 | 84 | 88 |
| Example 6-2 | 72 | 156 | 88 | 88 |
| Example 1-1 | 73 | 156 | 92 | 90 |
| Example 6-3 | 75 | 156 | 94 | 92 |
| Example 6-4 | 76 | 156 | 93 | 85 |
| Example 6-5 | 63 | 154 | 90 | 91 |
| Example 6-6 | 71 | 154 | 91 | 90 |
| Example 6-7 | 74 | 156 | 93 | 91 |
| Example 6-8 | 74 | 156 | 92 | 90 |
| Example 6-9 | 75 | 162 | 92 | 91 |
| Example 6-10 | 74 | 158 | 93 | 93 |
| Example 6-11 | 72 | 153 | 89 | 88 |
| Example 6-12 | 71 | 153 | 83 | 88 |
| Example 6-13 | 70 | 155 | 91 | 92 |
| Example 6-14 | 76 | 154 | 90 | 92 |
| Example 6-15 | 75 | 155 | 93 | 89 |
| Example 6-16 | 77 | 155 | 90 | 88 |
| Example 6-17 | 74 | 154 | 92 | 90 |
| Example 6-18 | 75 | 155 | 92 | 92 |
| Example 6-19 | 75 | 154 | 92 | 91 |

As shown in Table 7, the nonaqueous electrolyte secondary battery in any Example was superior both in discharge rate characteristics and high-temperature storage characteristics. Among these Examples, the nonaqueous electrolyte secondary battery of Example 6-1 employing the positive electrode active material represented by General Formula LiₓNi_{1-(y+z)}Co_{y}M_{z}O₂, wherein x is less than 0.95, shows a tendency to deteriorate more in discharge rate characteristics than other batteries. Seemingly it is because the battery was discharged at a rate practically higher with respect to the theoretical capacity. On the contrary, the nonaqueous electrolyte secondary battery of Example 6-4 employing the positive electrode active material wherein x is more than 1.12 shows a tendency to deteriorate more in high-temperature storage characteristics than other batteries. It is seemingly because the lithium compounds such as lithium carbonate are more easily produced on the active material surface, generating gas during storage at high temperature. In addition, the nonaqueous electrolyte secondary battery of Example 6-5 employing the positive electrode active material wherein y is less than 0.01 shows a tendency to deteriorate more in lifetime characteristics than other batteries. It is seemingly because the crystal stability of the positive electrode active material deteriorated. On the contrary, the nonaqueous electrolyte secondary battery of Example 6-8 employing a positive electrode active material wherein y is more than 0.35 shows no apparent deterioration in properties, but demands a rare metal Co in a greater amount, which leads to increase in cost of the active material. The nonaqueous electrolyte secondary battery of Example 6-9 employing the positive electrode active material wherein z is less than 0.01 shows a tendency to deteriorate more in thermal stability than other batteries. On the contrary, the nonaqueous electrolyte secondary battery of Example 6-12 employing the positive electrode active material wherein z is more than 0.50 demands Mn (M in the General Formula) in a greater amount, which leads to decrease in the capacity. Further, the nonaqueous electrolyte secondary batteries of Examples 6-14 to 6-19 employing, as its positive electrode active material, a transition metal-containing composite oxide of which part of Co is replaced with Mn and at least one element selected from Ti, Mg, Mo, Y, Zr, and Ca were superior in any characteristics. The results above indicate that the transition metal-containing composite oxide represented by General Formula LiₓNi_{1-(y+z)}Co_{y}M_{z}O₂ (0.95≦x≦1.12, 0.01≦y≦0.35, 0.01≦z≦0.50, and M represents at least one element selected from the group consisting of Al, Mn, Ti, Mg, Mo, Y, Zr, and Ca) is preferable as the positive electrode active material. In addition, when the transition metal-containing composite oxide represented by the General Formula wherein M contains Mn and at least one element selected from the group consisting of Ti, Mg, Mo, Y, Zr, and Ca is used as the positive electrode active material, it is possible to obtain the nonaqueous electrolyte secondary battery well-balanced in battery characteristics at high level.

### Example 7

Then, the relationship between the positive electrode active material and the battery characteristics of nonaqueous electrolyte secondary batteries employing the nonaqueous electrolyte solution containing the additives (A) and (B) was studied.

### Example 7-1

A nonaqueous electrolyte secondary battery of Example 7-1 was prepared in a similar manner to Example 1-1, except that a mixture of Li_{1.05}Ni_{1/3}Co_{1/3}Mn_{1/3}O₂ and LiCoO₂ at a mass ratio of 70:30 was used as the positive electrode active material in Example 1-1. The LiCoO₂ used in the present Example was prepared by the following method.

An aqueous metal salt solution containing cobalt sulfate at a concentration of 1 mol/L was first prepared. To the aqueous metal salt solution at 50° C. while stirred, an aqueous solution containing sodium hydroxide at 30 mass % was added to pH 12, giving a precipitate of cobalt hydroxide by coprecipitation. The precipitate was filtered, washed with water, and dried in air at 80° C. The precipitate was then sintered at 400° C. for 5 hours, to give cobalt oxide. The oxide obtained was found to be in a single phase, by powder X-ray diffraction analysis.

Then, lithium carbonate was added to the cobalt oxide obtained at a Co/Li molar ratio of 1:1. The mixture was placed in a rotary kiln and heated preliminary in air atmosphere at 650° C. for 10 hours. The preheated mixture from the rotary kiln was placed in an electric furnace, heated from room temperature to 850° C. over 2 hours, and sintered at 850° C. for 10 hours, to give desired LiCoO₂. The LiCoO₂ obtained was found to have a single-phase hexagonal layered structure by powder X-ray diffraction analysis. It is further pulverized and classified, to give the positive electrode active material powder (average diameter: 10.3 μm, specific surface area: 0.38 m²/g).

### Comparative Example 13

A nonaqueous electrolyte secondary battery of Comparative Example 13 was prepared in a similar manner to Example 7-1, except that PRS was used as the additive (A) at 2 mass % and the additive (B) was not used in Example 7-1.

### Comparative Example 14

A nonaqueous electrolyte secondary battery of Comparative Example 14 was prepared in a similar manner to Example 7-1, except that LiBF₄ was used as the additive (B) at 2 mass % and the additive (A) was not used in Example 7-1.

Each of the nonaqueous electrolyte secondary batteries above was subjected to the initial charge and discharge under the same condition as that in Example 1, and the discharge rate test and the high-temperature storage test were performed under the same condition as that of Example 1. The results are summarized in Table 8.

TABLE 8

| | | | | High- |
|---|---|---|---|---|
| | | | | temperature |
| | | End | Discharge rate | storage |
| | | voltage of | characteristics | characteristics |
| Battery | Additive | charge (V) | (%) | (%) |
| Example 7-1 | A: PRS | 4.4 | 93 | 91 |
| | (1 mass %) | | | |
| | B: LiBF₄ | | | |
| | (1 mass %) | | | |
| Comparative | A: PRS | 4.4 | 93 | 77 |
| Example 13 | (2 mass %) | | | |
| | B: none | | | |
| Comparative | A: none | 4.4 | 93 | 75 |
| Example 14 | B: LiBF₄ | | | |
| | (2 mass %) | | | |

As apparent from the results in Table 8, it is possible to obtain the favorable high-temperature storage characteristics by adding both additives (A) and (B) to the nonaqueous electrolyte solution even when a mixture of Li_{1.05}Ni_{1/3}Co_{1/3}Mn_{1/3}O₂ and LiCoO₂ is used as the positive electrode active material.

### Example 8

Then, the relationship between the negative electrode active material and the battery characteristics of nonaqueous electrolyte secondary batteries employing the nonaqueous electrolyte solution containing the additives (A) and (B) was studied.

### Example 8-1

A nonaqueous electrolyte secondary battery of Example 8-1 was prepared in a similar manner to Example 1-1, except that the carbon material used in Example 1-1 as the negative electrode active material was replaced with a silicon oxide represented by Formula SiO_{0.5}. The SiO_{0.5} used in the present Example was prepared by the following method:

Pure silicon at a purity of 99.9999% (manufactured by Kojundo Chemical Laboratory Co., Ltd.) was used as a target material for use in a vapor deposition device having an electron-beam heating means (Ulvac, Inc.). An electrolytic copper foil (manufactured by Furukawa Circuit Foil Co., Ltd., thickness: 35 μm) was placed on the fixing table in the device at an angle of 63 degrees to the horizontal plane. The target was placed immediately under it. An oxygen gas at a purity of 99.7% was supplied into the device at a flow rate of 80 sccm (manufactured by Nippon Sanso Corp.). A negative electrode active material layer of a compound containing silicon and oxygen (silicon oxide) was formed on the copper foil placed on the fixing table, while electron beam was irradiated to the target at an accelerating voltage of −8 kV and an emission of 500 mA. The deposition amount was so adjusted as to make the load capacity 1,760 mAh/g when the end voltage of charge is 4.4 V. The sample obtained was folded in half with the negative electrode active material layer facing outward and cut into a piece having a width of 58.5 mm and a length of 580 mm. A negative electrode lead was connected to the piece, to give a negative electrode. The oxygen amount contained in the negative electrode active material layer obtained was determined quantitatively by a combustion method, showing that the composition of the silicon oxide was SiO_{0.5}.

### Comparative Example 15

A nonaqueous electrolyte secondary battery of Comparative Example 15 was prepared in a similar manner to Example 8-1, except that PRS was used as the additive (A) at 2 mass % and no additive (B) was used in Example 8-1.

### Comparative Example 16

A nonaqueous electrolyte secondary battery of Comparative Example 16 was prepared in a similar manner to Example 8-1, except that LiBF₄ was used as the additive (B) at 2 mass % and no additive (A) was used in Example 8-1.

### Example 8-2

A nonaqueous electrolyte secondary battery of Example 8-2 was prepared in a similar manner to Example 8-1, except that the silicon oxide used in Example 8-1 as the negative electrode active material was replaced with pure silicon. The negative electrode used in the present Example was prepared in a similar manner to Example 8-1, except that oxygen gas was not supplied in the process of producing a negative electrode in Example 8-1.

### Comparative Example 17

A nonaqueous electrolyte secondary battery of Comparative Example 17 was prepared in a similar manner to Example 8-2, except that PRS was used as the additive (A) at 2 mass % and no additive (B) was used in Example 8-2.

### Comparative Example 18

A nonaqueous electrolyte secondary battery of Comparative Example 18 was prepared in a similar manner to Example 8-2, except that LiBF₄ was used as the additive (B) at 2 mass % and no additive (A) was used in Example 8-2.

Each of the batteries was subjected to the initial charge and discharge under the same condition as that in Example 1, and the discharge rate test and the high-temperature storage test were performed under the same condition as that in Example 1. The results are summarized in Table 9.

TABLE 9

| | | | | High- |
|---|---|---|---|---|
| | | | | temperature |
| | | End | Discharge rate | storage |
| | | voltage of | characteristics | characteristics |
| Battery | Additive | charge (V) | (%) | (%) |
| Example 8-1 | A: PRS | 4.4 | 94 | 89 |
| | (1 mass %) | | | |
| | B: LiBF₄ | | | |
| | (1 mass %) | | | |
| Comparative | A: PRS | 4.4 | 94 | 68 |
| Example 15 | (2 mass %) | | | |
| | B: none | | | |
| Comparative | A: none | 4.4 | 94 | 65 |
| Example 16 | B: LiBF₄ | | | |
| | (2 mass %) | | | |
| Example 8-2 | A: PRS | 4.4 | 92 | 87 |
| | (1 mass %) | | | |
| | B: LiBF₄ | | | |
| | (1 mass %) | | | |
| Comparative | A: PRS | 4.4 | 93 | 66 |
| Example 17 | (2 mass %) | | | |
| | B: none | | | |
| Comparative | A: none | 4.4 | 93 | 63 |
| Example 18 | B: LiBF₄ | | | |
| | (2 mass %) | | | |

As apparent from the results in Table 9, it is possible to prepare the nonaqueous electrolyte secondary battery superior in discharge rate characteristics and high-temperature storage characteristics by using the nonaqueous electrolyte solution containing both additives (A) and (B), even if the nonaqueous electrolyte secondary battery employs Si alone or a compound of Si and O as the negative electrode active material.

As described above in detail, an aspect of the present invention is a nonaqueous electrolyte secondary battery, comprising a positive electrode containing a transition metal-containing composite oxide as a positive electrode active material, a negative electrode containing a negative electrode active material allowing reversible insertion and extraction of lithium, a separator, and a nonaqueous electrolyte solution, wherein the nonaqueous electrolyte solution contains at least one additive (A) selected from the group consisting of ethylene sulfite, propylene sulfite and propane sultone and at least one additive (B) selected from the group consisting of maleic anhydride, vinylene carbonate, vinylethylene carbonate and LiBF₄, and an end voltage of charge is 4.3 to 4.5 V. In the configuration above, the additive (B) preferentially decomposes on the negative electrode surface, forming a film. And the additive (A), which has been considered to form a film on the negative electrode surface, becomes adsorbed and decomposed on the positive electrode surface, forming a film, in interaction with the transition metal-containing composite oxide in the high-voltage charged state. The film formed in interaction between the transition metal-containing composite oxide in the high-voltage state and the additive (A) prevents elution of metal ions from the positive electrode active material drastically when the battery in the charged state is stored at high temperature. It also keeps the addition amounts of the additives lower because the additive (B) forms a film preferentially on the negative electrode surface, and prevents increase of the impedance of the nonaqueous electrolyte solution because both additives form a film respectively on the electrode surfaces. Accordingly, even when the high end voltage of charge of 4.3 to 4.5 V is used for increase in capacity, it is possible to obtain the nonaqueous electrolyte secondary battery superior in discharge rate characteristics and high-temperature storage characteristics.

The total content of the additives (A) and (B) in the nonaqueous electrolyte solution is preferably 0.1 to 10 mass %. In the configuration above, it is possible to reduce the total amount of both additives in the nonaqueous electrolyte solution, because the additive (B) forms a film preferentially on the negative electrode and the additive (A) forms a film on the positive electrode in the high-voltage charged state. Accordingly, it is possible to improve the high-temperature storage characteristics and prevent deterioration of the discharge rate characteristics at such small addition amounts.

In addition, the positive electrode preferably contains, as the positive electrode active material, a transition metal-containing composite oxide represented by General Formula LiₓNi_{1-(y+z)}Co_{y}M_{z}O₂ (wherein, 0.95≦x≦1.12, 0.01≦y≦0.35, 0.01≦z≦0.50, and M represents at least one element selected from the group consisting of Al, Mn, Ti, Mg, Mo, Y, Zr, and Ca) that has a specific surface area of 0.15 to 1.50 m²/g. The transition metal-containing composite oxide in the composition allows use of the high end voltage of charge and gives a favorable film by adsorption or decomposition of the additive (A) on the surface of the active material during high-voltage charge. The transition metal-containing composite oxide having a specific surface area in the range above has a smaller charge transfer resistance on the surface and allows less elution of metal ions. Thus, it is possible to keep both the discharge rate characteristics and the high-temperature storage characteristics favorable at high level.

When the transition metal-containing composite oxide containing Mn and at least one element selected from the group consisting of Al, Ti, Mg, Mo, Y, Zr, and Ca as M in the General Formula LiₓNi_{1-(y+z)}Co_{y}M_{z}O₂ is used as the positive electrode active material, it is possible to prepare the nonaqueous electrolyte secondary battery favorable both in the discharge rate characteristics and the high-temperature storage characteristics at high level and also superior in capacity characteristics and thermal stability.

The positive electrode may contain LiCoO₂ additionally as the positive electrode active material. In the configuration above, it is possible to obtain the nonaqueous electrolyte secondary battery superior in the discharge rate characteristics and the high-temperature storage characteristics, even when the positive electrode contains multiple positive electrode active materials.

The negative electrode may contain a carbon material as the negative electrode active material allowing reversible insertion and extraction of lithium. In the configuration, it is possible to improve the discharge rate characteristics and the high-temperature storage characteristics, even when the nonaqueous electrolyte secondary battery employs the negative electrode containing the carbon material as the negative electrode active material.

The negative electrode containing the carbon material as the negative electrode active material preferably has a load capacity (X/Y), a rate of the theoretical battery capacity (X) to the mass of the carbon material (Y), of 250 to 360 mAh/g. When the load capacity is in the range above, it is possible to obtain the nonaqueous electrolyte secondary battery more superior in the discharge rate characteristics and the high-temperature storage characteristics, because lithium ions are inserted and extracted more smoothly and deterioration of the polarization characteristics is prevented.

The negative electrode may contain one or both of Si alone and a compound of Si and O as the negative electrode active material allowing reversible insertion and extraction of lithium. In the configuration above, it is possible to improve the discharge rate characteristics and the high-temperature storage characteristics, even when the nonaqueous electrolyte secondary battery employs the negative electrode containing the high-capacity silicon-based material as its negative electrode active material.

In preparation of the nonaqueous electrolyte secondary battery with the aspect above, it is preferable to have an assembling step of placing an electrode assembly having the positive electrode, the negative electrode and the separator, and the nonaqueous electrolyte solution in a battery case, and a high-voltage-charging step of charging the nonaqueous electrolyte secondary battery to a voltage in the range of 4.3 to 4.5 V at least once after the assembling step. In the configuration above, the advantageous effects of the additives (A) and (B) on the discharge rate characteristics and the high-temperature storage characteristics are shown more distinctively, because the additive (B) forms a film preferentially on the negative electrode surface and the additive (A) forms a film mainly on the positive electrode surface during the high-voltage charge.

The high-voltage-charging step of charging the battery to a voltage in the range of 4.3 to 4.5 V is preferably carried out at least twice. In the configuration, it is possible to improve the discharge rate characteristics and the high-temperature storage characteristics more reliably, because the respective film is formed sufficiently on each surface of the positive and negative electrodes.

It is also preferable to have a preliminary charging/discharging step of performing at least one charge/discharge cycle at an end voltage of preliminary charge of lower than 4.3 V and an end voltage of preliminary discharge of 3.0 V or higher between the assembling step and the high-voltage-charging step. In the configuration, it is possible to form a film of the additive (B) preferentially on the negative electrode surface, by previously charging and discharging the battery at the low voltage that does not lead to progress of adsorption or decomposition of the additive (A) on the negative electrode surface. It is thus possible to further improve the discharge rate characteristics and the high-temperature storage characteristics, because the film of the additive (B) is previously formed on the area of the negative electrode surface interacting with the additive (A) by the preliminary charging at the low voltage and then, the film of the additive (A) is formed on the positive electrode surface by charging the battery at high voltage.

In preparation of the nonaqueous electrolyte secondary battery above, the positive electrode preferably contains, as the positive electrode active material, a transition metal-containing composite oxide represented by General Formula LiₓNi_{1-(y+z)}Co_{y}M_{z}O₂ (wherein, 0.95≦x≦1.12, 0.01≦y≦0.35, 0.01≦z≦0.50, and M represents at least one element selected from the group consisting of Al, Mn, Ti, Mg, Mo, Y, Zr, and Ca) that has a specific surface area of 0.15 to 1.50 m²/g. The transition metal-containing composite oxide represented by the Formula of the composition above allows use of a high end voltage of charge and formation of a favorable film on the surface by adsorption or decomposition of the additive (A) during high-voltage charging. In addition, the transition metal-containing composite oxide having the specific surface area in the range above has a smaller charge transfer resistance on the surface and is resistant to elution of metal ions. Accordingly, it is possible to keep both the discharge rate characteristics and the high-temperature storage characteristics favorable at high level.

When the transition metal-containing composite oxide containing Mn and at least one element selected from the group consisting of Al, Ti, Mg, Mo, Y, Zr, and Ca as M in the General Formula LiₓNi_{1-(y+z)}Co_{y}M_{z}O₂ is used as the positive electrode active material, it is possible to prepare the nonaqueous electrolyte secondary battery more favorable in the discharge rate characteristics and the high-temperature storage characteristics at high level and also superior in the capacity characteristics and the thermal stability.

### INDUSTRIAL APPLICABILITY

The nonaqueous electrolyte secondary battery according to the present invention, which has large capacity and is superior in discharge rate characteristics and high-temperature storage characteristics, can be used as a secondary battery for use in portable devices such as cellphone. It can also be used as a power source, for example, for driving a high-output electric tool.

1. A nonaqueous electrolyte secondary battery, comprising a positive electrode containing a transition metal-containing composite oxide as a positive electrode active material, a negative electrode containing a negative electrode active material allowing reversible insertion and extraction of lithium, a separator, and a nonaqueous electrolyte solution, wherein
the nonaqueous electrolyte solution contains at least one additive (A) selected from the group consisting of ethylene sulfite, propylene sulfite, and propane sultone and at least one additive (B) selected from the group consisting of maleic anhydride, vinylene carbonate, vinylethylene carbonate, and LiBF₄; and
an end voltage of charge is 4.3 to 4.5 V.

2. The nonaqueous electrolyte secondary battery according to claim 1, wherein the total content of the additives (A) and (B) in the nonaqueous electrolyte solution is 0.1 to 10 mass %.

3. The nonaqueous electrolyte secondary battery according to claim 1, wherein the positive electrode contains as the positive electrode active material a transition metal-containing composite oxide represented by General Formula LiₓNi_{1-(y+z)}Co_{y}M_{z}O₂ (wherein, 0.95≦x≦1.12, 0.01≦y≦0.35, 0.01≦z≦0.50, and M represents at least one element selected from the group consisting of Al, Mn, Ti, Mg, Mo, Y, Zr, and Ca) that has a specific surface area of 0.15 to 1.50 m²/g.

4. The nonaqueous electrolyte secondary battery according to claim 3, wherein M in the General Formula LiₓNi_{1-(y+z)}Co_{y}M_{z}O₂ contains Mn and at least one element selected from the group consisting of Al, Ti, Mg, Mo, Y, Zr, and Ca.

5. The nonaqueous electrolyte secondary battery according to claim 3, wherein the positive electrode contains LiCoO₂ additionally as the positive electrode active material.

6. The nonaqueous electrolyte secondary battery according to claim 1, wherein the negative electrode contains a carbon material as the negative electrode active material allowing reversible insertion and extraction of lithium.

7. The nonaqueous electrolyte secondary battery according to claim 6, wherein the load capacity (X/Y), a rate of the theoretical battery capacity (X) to the mass of the carbon material (Y), is 250 to 360 mAh/g.

8. The nonaqueous electrolyte secondary battery according to claim 1, wherein the negative electrode contains one or both of Si alone and a compound of Si and O as the negative electrode active material allowing reversible insertion and extraction of lithium.

9. A method of producing a nonaqueous electrolyte secondary battery having a positive electrode containing a transition metal-containing composite oxide as a positive electrode active material, a negative electrode containing a negative electrode active material allowing reversible insertion and extraction of lithium, a separator and a nonaqueous electrolyte solution, wherein
the nonaqueous electrolyte solution contains at least one additive (A) selected from the group consisting of ethylene sulfite, propylene sulfite, and propane sultone and at least one additive (B) selected from the group consisting of maleic anhydride, vinylene carbonate, vinylethylene carbonate, and LiBF₄; and
the method comprising
an assembling step of placing an electrode assembly having the positive electrode, the negative electrode and the separator, and the nonaqueous electrolyte solution in a battery case and
a high-voltage-charging step of charging the nonaqueous electrolyte secondary battery to a voltage in the range of 4.3 to 4.5 V at least once after the assembling step.

10. The method of producing a nonaqueous electrolyte secondary battery according to claim 9, wherein the high-voltage-charging step includes charging to a voltage in the range of 4.3 to 4.5 V at least twice.

11. The method of producing a nonaqueous electrolyte secondary battery according to claim 9, further comprising a preliminary charging/discharging step of performing at least one charge/discharge cycle at an end voltage of preliminary charge of lower than 4.3 V and an end voltage of preliminary discharge of 3.0 V or higher between the assembling step and the high-voltage-charging step.

12. The method of producing a nonaqueous electrolyte secondary battery according to claim 9, wherein the positive electrode contains, as the positive electrode active material, a transition metal-containing composite oxide represented by General Formula LiₓNi_{1-(y+z)}Co_{y}M_{z}O₂ (wherein, 0.95≦x≦1.12, 0.01≦y≦0.35, 0.01≦z≦0.50, and M represents at least one element selected from the group consisting of Al, Mn, Ti, Mg, Mo, Y, Zr, and Ca) that has a specific surface area of 0.15 to 1.50 m²/g.

13. The method of producing a nonaqueous electrolyte secondary battery according to claim 12, wherein M in the General Formula LiₓNi_{1-(y+z)}Co_{y}M_{z}O₂ contains Mn and at least one element selected from the group consisting of Al, Ti, Mg, Mo, Y, Zr, and Ca.
